(19) United States
(12) Patent Application Publication
(10) Pub. No.: US 2026/0105087 A1
(43) Pub. Date: Apr. 16, 2026

(54) Recommendation System Using a Language Model Neural Network

(71) Applicant: Google LLC, Mountain View, CA (US)

(72) Inventors: Dong-Ho Lee, Marina Del Ray, CA (US); Adam Wiggen Kraft, Mountain View, CA (US); Long Jin, Mountain View, CA (US); Nikhil Mehta, San Jose, CA (US); Taibai Xu, Santa Clara, CA (US); Lichan Hong, Los Altos, CA (US)

(21) Appl. No.: 19/355,641

(22) Filed: Oct. 10, 2025

Related U.S. Application Data
(60) Provisional application No. 63/706,438, filed on Oct. 11, 2024.

(51) Int. Cl. G06F 16/3332

(52) U.S. Cl. CPC G06F 16/3334

(57) ABSTRACT

The present disclosure provides systems and methods that obtain, for a particular user who is one of plurality of users, a recommendation which specifies one or more recommended items from plurality of items associated with respective text data. Each of the plurality of users is associated with a respective subset of the plurality of items, which may be items they have previously purchased. A score is obtained for each of the plurality of items. The score is based on semantic terms generated based on encodings, by a language model neural network, of a prompt based on the text data for the item and encodings of prompts based on text data for the subset of items associated with the particular user. The language model neural network need not have been specifically trained for this task.

### RELATED APPLICATIONS

This application claims priority to and the benefit of U.S. Provisional Patent Application No. 63/706,438, filed Oct. 11, 2024. U.S. Provisional Patent Application No. 63/706,438 is hereby incorporated by reference in its entirety.

### FIELD

The present disclosure relates generally to systems and methods for recommending items, and more particularly to systems and methods implemented using a language model neural network.

### BACKGROUND

Personalized recommendation systems are tools which recommend at least one item selected from a plurality of items, to users of the recommendation system. The recommendations are customized to particular users based on information known about the users, and so enhance user experience by allowing more rapid access to items which meet user-specific criteria.

The items may be media items, such as items which comprise any one or more of image data, sound data, video data and text data. Alternatively, the items may be physical products, such as products which are for sale in a physical or online store. Recommendation systems are also common for recommending items which are websites, articles and other types of informational content. The recommendation system may be a portion of an item provision system for providing items to the user. If the items are media items, for example, the item provision system may be a library or online store for media items, and include functionality for supplying to a user a media item chosen by the user, for example as a download from a database of items maintained or accessed by the item provision system. Alternatively, if the items are physical products, the item provision system may include a system for delivering an item chosen by the user. In either case, the item provision system may include a mechanism for receiving a payment from the user for the item.

In any of these cases, the items may be associated with text data (metadata) which may be assessable by the recommendation system. The text data may comprise data contained within the item (e.g. if the item is a literary work, the data may be a precis of the literary work, e.g. generated automatically by the recommendation system) and/or may comprise text data authored by a supplier of the item, such as an item description of the item.

### SUMMARY

Aspects and advantages of embodiments of the present disclosure will be set forth in part in the following description, or can be learned from the description, or can be learned through practice of the embodiments.

In general terms, the present disclosure provides systems and methods that obtain, for a particular user who is one of a plurality of users, a recommendation which specifies one or more recommended items from plurality of items. Each of the items is associated with respective text data, and each of the plurality of users is associated with a respective subset of the plurality of items (which may be items that user has interacted with in the past, e.g. bought or viewed or listened to). A score is obtained for each item. The score for the items includes a semantic term generated based on an encoding of a prompt based on the text data for item and encodings of respective prompts based on the text data for the subset of items associated with the particular user, where the encodings are produced by an embedding portion of a language model neural network, such as a large language model (LLM). The score for the item is also based on collaborative data, indicative of a similarity between any of the users who have interacted with the item (that is, the subset of items associated with those users includes the item) and any of users who have interacted with the subset of items associated with the particular user (that is, the subset of items associated with those users includes items in the subset of items associated with the particular user). Based on the scores, a preliminary recommendation may be made, in a process called here “retrieval”. The preliminary recommendation may optionally be refined using the language model, a process called here “ranking”.

It has been found that implementations of the method can produce recommendations which are comparable, or even superior, in quality to other known recommendation systems, even if the implementations do not use a language model neural network which has been specifically trained (“fine-tuned”) for this task. Thus, costs associated with fine tuning a language model neural network, as happens in some known recommendation systems, can be avoided. Although some known recommendation systems do not use a language model neural network, they do typically include another form of trained machine learning model, and the costs of training such a learning model are not incurred in implementations of the present disclosure described below.

One example aspect of the present disclosure is directed to a computer-implemented method for obtaining a recommendation which specifies one or more recommended items selected from a plurality of items, each of the plurality of items being associated with respective text data, the recommendation being for a particular user who is one of a plurality of users, each user of the plurality of users being associated with a respective subset of the plurality of items, the method comprising: obtaining, for each item of the plurality of the items, a corresponding semantic term for each item in the subset of items associated with the particular user, the sematic term being a measure of the similarity between an encoding by an embedding portion of the language model neural network of a prompt based on the text data of the item of the plurality of items, and an encoding by the embedding portion of the language model neural network of a prompt based on the text data of the item in the subset of items associated with the particular user; obtaining, for each item of the plurality of items, corresponding collaborative data indicative of a similarity between ones of the users for whom the associated subset of items includes the item and ones of the users for whom the associated subset of items includes items in the subset of items associated with the particular user; determining a respective score for each of the plurality of items based on the corresponding semantic terms and the corresponding collaborative data; and determining the recommended items based on the respective scores for the plurality of items.

Another example of the present disclosure is directed to a computer system for obtaining, for a user who is one of a plurality of users, a recommendation which specifies one or more recommended items selected from a plurality of items, each of the plurality of items being associated with respective text data, and each user of the plurality of users being associated with a respective subset of the plurality of items, the computing system comprising: at least one processor; and at least one tangible, non-transitory computer-readable medium that stores instructions that, when executed by the at least one processor, cause the computing system to: obtain, for each item of the plurality of the items, a corresponding semantic term for each item in the subset of items associated with the particular user, the sematic term being a measure of the similarity between an encoding by an embedding portion of the language model neural network of a prompt based on the text data of the item of the plurality of items, and an encoding by the embedding portion of the language model neural network of a prompt based on the text data of the item in the subset of items associated with the particular user; obtain, each item of the plurality of items, corresponding collaborative data indicative of a similarity between ones of the users for whom the associated subset of items includes the item and ones of the users for whom the associated subset of items includes items in the subset of items associated with the particular user; determine a respective score for each of the plurality of items based on the corresponding semantic terms and the corresponding collaborative data; and determine the recommended items based on the respective scores for the plurality of items.

Another example aspect of the present disclosure is directed to one or more tangible, non-transitory computer-readable media storing computer-readable instructions that when executed by one or more processors cause the one or more processors to perform a plurality of operations to obtain, for a user who is one of a plurality of users, a recommendation which specifies one or more recommended items selected from a plurality of items, each of the plurality of items being associated with respective text data, and each user of the plurality of users being associated with a respective subset of the plurality of items; the operations comprising: obtaining, for each item of the plurality of the items, a corresponding semantic term for each item in the subset of items associated with the particular user, the sematic term being a measure of the similarity between an encoding by an embedding portion of the language model neural network of a prompt based on the text data of the item of the plurality of items, and an encoding by the embedding portion of the language model neural network of a prompt based on the text data of the item in the subset of items associated with the particular user; obtaining, for each item of the plurality of items, corresponding collaborative data indicative of a similarity between ones of the users for whom the associated subset of items includes the item and ones of the users for whom the associated subset of items includes items in the subset of items associated with the particular user; determining a respective score for each of the plurality of items based on the corresponding semantic terms and the corresponding collaborative data; and determining the recommended items based on the respective scores for the plurality of items.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical representation of an example training-free approach for recommendation.

FIG. 2 depicts a graphical diagram of an example framework for training-free recommendation.

FIG. 3 depicts a graphical representation of an example prompt overview for a ranking pipeline.

FIG. 4 depicts a block diagram of an example computing system according to example embodiments of the present disclosure which operates as a recommendation system;

FIG. 5 depicts data associated with a user of the recommendation system of FIG. 4; and

FIG. 6 depicts a flow chart diagram of an example method to perform a recommendation according to embodiments of the present disclosure.

### DETAILED DESCRIPTION

The present disclosure provides a recommendation system for predicting which of a plurality of items is most suitable for a user, who is typically an individual. The items may for example be: media items, comprising any one or more of audio data, video data, still images or text; other products or services (e.g. physical products, hotels or holiday packages); travel destinations; information sources such as webpages on the Internet; or technical publications or patent publications in a library, such as an online library. The recommendation system can use various forms of information about the items, and one of these is a corresponding file of text data associated with each of the items. The text data may for example comprise (all or part of) a product description provided by a supplier of the item, or an abstract in the case of an abstract technical publication or patent document. The text data may in some cases be generated automatically; for example, in the case of an item which is a data file, it may be obtained by processing the item.

It is known to use a language model neural network in a recommendation system to process text data associated with items. In general terms, a language model neural network is a neural network which that has been trained so that, given a text prompt that includes a sequence of tokens in a natural language, the neural network can generate a textual response, which is also a sequence of tokens in the natural language.

Some language model neural networks are auto-regressive, in that the textual response is the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data.

Other language model neural networks are not auto-regressive. Some such language model neural networks generate the tokens of the language output simultaneously.

A language model neural network can be made to perform a particular task by providing a natural language description of the desired response as an input or “prompt”. In some cases, the prompt may be a few-shot prompt where a few, e.g., 1 to 10, examples of a query and an example output are provided in the text prior to the actual query.

It is surprising, but well-established, that large language model neural networks can perform tasks that they were not explicitly trained to perform. For example they can perform translation tasks (provided that the training corpus included words in different languages), arithmetic, and many other tasks.

However, the performance of LLMs in recommendations systems has generally been disappointing (that is, inferior to other known recommendations systems) unless the language model neural network has been “fine-tuned” to the task. Fine tuning refers to a process of obtaining a pre-trained language model neural network trained on a large corpus of examples as previously described and then further training part of all of the language model neural network on a relatively small number of examples particular to the type of task that is to be performed. This may be a relatively expensive process.

Many language model neural networks may be considered as an “encoder” and a “decoder”. The encoder is responsible for understanding and extracting relevant information from an input sequence (prompt), and generating a rich contextual representation of the prompt referred to as an “encoding”.

Some language model neural networks are a large language model (LLM) neural network, e.g., one that has greater than 1 billion, 10 billion or 100 billion trained parameters. Some language model neural networks have been trained on greater than 10 billion, 100 billion or 1000 billion words or tokens representing words or other text tokens, e.g., sub-words (also known as “word pieces”).

One of the first large language models, described in “Attention Is All You Need” by A. Vaswani et al., 2017, employed an attention mechanism referred to as a “transformer” (or “transformer neural network”), including a succession of self-attention neural network layers. This paper employed the transformer in an auto-regressive language model neural network comprising an encoder and an auto-regressive decoder. The encoder outputs a continuous representation (embedding) of the input text that is passed to the decoder, which generates target text (e.g. translated text) based on the continuous representation received from the encoder.

Various “encoder-only” language model neural network have since been developed based on the encoder model of the original transformer-based language model. A notable example is BERT, described in “BERT: Pre-training of Deep Bidirectional Transformers for Language Understanding”, J. Dervin et al., 2018. Encoder-only architectures typically do not generate output sequences one token at a time, conditioning each token on the previously generated tokens (that is, auto-regressively). Instead, they produce an “encoding” (or “embedding”) of the input text, which can be used for various downstream input text, which can be used for various downstream tasks such as sentiment analysis, question-answering and named entity recognition.

Furthermore, many LLMs have been proposed which employ both and encoder and a decoder, or encoder-decoder hybrids.

An implementation of the present technique may employ an encoder of any of these known language model neural networks, to generate an encoding of a prompt based on the respective text data associated with one or more of the items. The language model neural network may be a large language model neural network as defined above.

The encoding is used in a process for defining a respective score for each of a plurality of the items in relation to a particular user of the recommendation system, indicating a likelihood of the item being rated highly by the particular user of the recommendation system. Optionally, the plurality of items may be ones which have previously been selected from a larger set of items, e.g. a filtering operation. In other words, a filtering operation may be performed on the larger set of items, and a score is only defined for those items which remain.

The recommendation system may employ data relating to a plurality of users, one of whom is the particular user to whom a recommendation is to be made. In an example of the present disclosure appended hereto as Appendix A, the plurality of items is denoted by the set/and has a number of elements denoted n. Each item is labelled by a corresponding value of an index variable x. Each user is labelled by a corresponding value of an index variable u. The set of all users is denoted U.

Each of the users is associated with a respective subset of the plurality of items, which may be denoted Sᵤ={s₁, s₂, . . . , s_{\hat{n}}}, where \hat{n} is the number of elements in the subset for the user u. The subset of the elements may represent a history of all the items the user has previously interacted with (e.g. purchased or accessed). Thus, the recommendation system may be considered as predicting a next item S_{\hat{n}+1}ϵI that the user u is most likely to interact with. As described below, the implementation may employ other information characterizing the interaction of the user with each of the items in the subset of the plurality of items.

To obtain a recommendation of one or more of the plurality of items for a particular one of the users, say user u, the recommendation system first derives a score for each of the plurality of items, I, and determines (identifies) one or more of the items for which the score is highest; a process termed here “retrieval”. The score for each item x, in respect of the particular user, is based on at least:
a “semantic term” for each item of the subset of the items associated with the particular user, which is indicative of how similar the text data associated with the item x is to text data of items the particular user has interacted with, and
“collaborative data” indicating a similarity between the users who have interacted with the item x, and the users who have interacted with the items which the particular user has also interacted with.

The collaborative data may be in the form of a “collaborative term” for each item of the subset of items associated with the user. The respective score for an item x of the plurality of items may, for example, be a weighted sum, over the items in the subset of the items associated with the particular user, of the corresponding semantic term and the corresponding collaborative term.

Once the score for each item x, in respect of the particular user, has been obtained, the items for which the score is highest may be determined. This completes the retrieval process.

Optionally, the item(s) recommended to the user may be the items which are determined to have the highest scores.

Alternatively, a plurality k of the items having the highest scores may be subject to an additional process, described below, in which an order is defined among the k items (a process called “ranking). The one or more items recommended to the particular user may be the item(s) which are highest ranked following this process.

During the retrieval process, the semantic term, for a given item x of I and a given item sⱼ which is a j-th one of the items in the subset of items associated with the particular user, is a measure of the similarity between an encoding (denoted Eₓ), generated by an embedding portion of a language model neural network, of a prompt based on the text data of the item x of the plurality of items, and an encoding (denoted Eⱼ), by the embedding portion of the language model neural network, of a prompt based on the text data of the item sⱼ in the subset Sᵤ={s₁, s₂, . . . , s_{\hat{n}}} of the data items associated with the particular user. The encodings Eₓ and Eⱼ may each be dₑ dimensional vectors, where dₑ is an integer. Optionally, the embeddings for some or all of the n items (the plurality of items) have been calculated in advance (i.e. before the retrieval process begins) as a matrix Eϵ [symbol] ^{n×d}^{ₑ}.

In one form, each semantic term may be a value, which may be denoted

$${R}_{S}^{x j} ,$$

indicating the similarity (e.g. as indicated by a similarity measure, such as a cosine product) between the encoding Eₓ of the prompt based on the text data of the item x of the plurality of items, and the encoding Eⱼ of the prompt based on the text data of item sⱼ which is a member of the subset of the data items associated with the particular user. A corresponding value

$${R}_{S}^{x j}$$

is obtained for each item sⱼ of the subset Sᵤ={s₁, s₂, . . . , s_{\hat{n}}} of data items associated with the particular user.

The collaborative data for a given item x which is a member of I, may include a corresponding collaborate term for each item sⱼ which is one of the items in the subset of items associated with the user. The collaborative term is indicative of a similarity between those users (if any) for whom the associated subset of items includes the item x, and those users (if any) for whom the associated subset of items includes the item sⱼ. For example, the collaborative term may be the number of users for whom the respective associated subset of items includes both x and sⱼ.

Specifically, for each of the item sⱼ of the subset of items for the particular user, the corresponding collaborative term may be formed as respective value

$${R}_{C}^{x j}$$

which is the cosine similarity between an m-dimensional vector Cₓ, which indicates which of the m users have interacted with the element x (i.e. for which of the m users the associated subset of items includes the item x) and an m-dimensional vector Cⱼ, which indicates which of the m users have interacted with the item sⱼ. Each element of m-dimensional the vectors Cₓ and Cⱼ corresponds to one of the m users, and it may for example be 1 or 0 according to whether, for the user corresponding to the element, the associated subset of items corresponding to the user includes the item x or sⱼ respectively.

The score may be formed as a sum, over the items sⱼ in the subset of items associated with the particular user, of a respective weight wⱼ for the corresponding item in the subset of items associated with the particular user, multiplied by a weighted sum of the corresponding semantic term

$${R}_{S}^{x j}$$

and the corresponding collaborative term

$${R}_{C}^{x j} .$$

The weighted sum of the corresponding semantic term

$${R}_{S}^{x j}$$

and the corresponding collaborative term

$${R}_{C}^{x j}$$

may be denoted

$${aR}_{S}^{x j} + ( 1 - a ) {R}_{C}^{x j} ,$$

where a is a weighting term in the range 0<a<1. a is a hyper-parameter which may initially be chosen as a predetermined value or at random, and then iteratively modified to maximize the quality of recommendations made by the recommendation system.

Thus, the score for an item x is a sum over j of the values of

$${w}_{j} ( {aR}_{S}^{x j} + ( 1 - a ) {R}_{C}^{x j} ) .$$

Each item sⱼ in the subset of items associated with the particular user may be associated with a respective rating rⱼ assigned by the particular user, where higher values of rⱼ indicate that the particular user considered the item more suitable for himself/herself. The respective weight wⱼ for each item in the subset of items associated with the particular user is based on the respective rating rⱼ, e.g. may be proportional to rⱼ.

Alternatively or additionally, each item sⱼ in the subset of items associated with the particular user, may be associated with a respective temporal value tⱼ indicative of a time which has passed since the particular user has interacted with the item. The respective weight wⱼ for each items in the subset of items associated with the particular user may be a decreasing function λ^{t}^{ⱼ} of the respective temporal value.

Additionally, the score for item x may be normalized based on the value of \hat{n} (the number of items sⱼ). Thus, the score for item x may be given by

$$score ( x ) = \frac{1}{\hat{n}} {\sum }_{j = 1}^{\hat{n}} {r}_{j} \cdot {λ}^{{t}_{j}} ( {aR}_{S}^{x j} + ( 1 - a ) {R}_{C}^{x j} ) . \qquad ( 1 )$$

As noted the k items for which the score is highest may be identified, where k is an integer which is at least one. Optionally, the recommendation transmitted to the user may indicate these k item(s).

Alternatively, in the case that k is more than one, as noted, the k items with the highest scores may be treated as “candidates”, such that the k items form a candidate subset of the plurality of data items I, and there may be a step of “ranking” the k candidates. The recommendation transmitted to the user by the recommendation system may indicate which of the k candidates have the highest ranking.

Specifically, one or more prompts may be defined using the text items for the k candidate items. For example, for each of the k candidate items, a respective prompt may be defined including the text data for the candidate item. The prompt may be processed by a language model neural network to generate a respective language model output, and the ranking may be performed based on the language model outputs.

The prompt for a given candidate item may be formed in several ways. Generally, it will include the text data for one or more of the candidate items. Optionally, it may include data identifying the items in the subset of items associated with the particular user, and optionally it may include the text data for the items in the subset of items associated with the particular user.

For example the prompt may be as follows:

The user has purchased the following items in the following order:
[A list of the items in the subset associated with the user, optionally including some or all of the text data for those items]
Here are some candidate items
[A list of the candidate items, optionally including their text data]
Rank the candidate items based on their alignment with the user's preferences.

Optionally, a given prompt may include data which is indicative, for one or more of the candidate items, of a number of the plurality of users for whom the respective associated subset of the plurality of items includes the item of the candidate dataset(s). This provides an indication of the overall popularity of the candidate data item(s).

Also, optionally, the prompt may additionally include, for one or more of the candidate items and for one or more other items of plurality of items (e.g. one or more other items of the candidate dataset), respective data indicative of a number of the plurality of users for whom the respective associated subset of the plurality of items includes both the item of the candidate dataset and the other item. In this case, the prompt indicates the co-occurrence of the candidate items in the subsets associated with the users.

Using the language model output(s), the ranking may be performed in various ways. For example, if the prompt has the format above, and, upon processing it, the language model generates a language model output which is a ranking of the candidate items, the final ranking may just be this order. The recommendation may be an indication of at least one item which is at the top of this ranking. In one example, the language model output may comprise a “veto”, indicating that a certain one or more of the candidate items should not be recommended to the user, and in this case the certain one or more of the candidate items may be moved to the bottom of the ranking, or excluded altogether.

Alternatively, an initial ordering of the candidate items may be defined, and then iteratively refined. The initial order may be based on the scores. For example, the initial order may exactly follow the scores of the candidate items, e.g. such that respective scores of the highest scoring candidates decrease monotonously from the first candidate item in the order to the last candidate item in the order. In each iteration, a “window” of two or more of the candidate items which have consecutive positions in the order may be selected, and the order of the candidate items in the window may be selectively adjusted upon a criterion being met. The criterion may, for example, be that a language model output indicates that a first candidate item in the window which is later in the order, would in fact be more popular with the particular user than another, second candidate item in the window which is earlier in the order. In this case, the adjustment to the order may be to reverse the positions of the first and second candidate items.

The systems and methods described herein may provide a number of technical effects and benefits. For instance, the present method does not require the language model to be “fine-tuned” to perform recommendations. Nevertheless, it has been demonstrated experimentally that a recommendation as described above may perform equivalently, or even better than, other recommendation systems which use a fine-tuned language model neural network or another fine-tuned machine learning system.

With reference now to the Figures, example embodiments of the present disclosure will be discussed in further detail.

### Example Training Free Recommendation System

This section initially outlines the problem formulation. Subsequent subsections then detail the proposed retrieval and ranking pipelines.

### Example Sequential Recommendation:

An example sequential recommendation task predicts the next item a user will interact with based on their interaction history. For a user uϵU, where U is the set of all users, the interaction history can, for example, be represented as a sequence of items Sᵤ={s₁, s₂, . . . , sₙ}, with each item sᵢϵI belonging to the set of all items I. Each user history item sᵢ can be associated with a rating rᵢϵ{1,2,3,4,5} given by the user u. One example goal is to predict the next item sₙ₊₁ϵI that the user is most likely to interact with.

### Example Retrieval Pipeline:

An example retrieval pipeline aims to assign a score to an unseen item x E/given the sequence Sᵤ. To achieve this, some example implementations leverage two scoring components: one that focuses on the semantic relationship between items and another that focuses on the collaborative relationship.

### Example Discussion of Semantic Relationships:

Understanding how similar a candidate item is to the items in a user's interaction history sᵤϵsᵤ is advantageous to accurately gauging how well candidate items align with user preferences. Therefore, some example implementations leverage LLM embedding models and pass in text prompts representing items and collect embedding vectors of dimension dₑ. Some example implementations construct a prompt based on the item information and metadata, which can include fields like title, description, category, brand, sales ranking, price, etc. Some example implementations collect embeddings for each item iϵI, resulting in Eϵ [symbol] ^{n×d}^{ₑ}, where n is number of total items in I.

The semantic relationship between two items (iₐ, i_{b}) can then be calculated using the cosine similarity between their embeddings Eᵢ_{ₐ}, Eᵢ_{_{b}}ϵE. This measure provides a numerical representation of how closely related the items are in semantic space. Some example implementations precompute the entire semantic relationship matrix R_{S}ϵ [symbol] ^{n×n}. For many domains, this is a practical solution. However, if |I| is very large, Approximate Nearest Neighbor methods represent possible efficient approaches to maintain quality and reduce computation.

### Example Discussion of Collaborative Relationships

Semantic similarity between a candidate item and items in a user's interaction history is a helpful cue for assessing the similarity of items based on the item information. However, this alone does not fully capture the engagement interactions of items by multiple users. To better understand the collaborative relationship, one thread of analysis considers how frequently different combinations of items are interacted with by users. These shared interaction patterns can provide strong indicators of how likely the candidate item is to resonate with a broader audience with similar preferences. For each item iϵI, some example implementations derive an interaction array that represents user interactions, forming a set of sparse user-item interaction arrays Cϵ [symbol] ^{n×m}, where m is number of users in U. The collaborative relationship between two items (iₐ, i_{b}) can then be computed by using the cosine similarity between their sparse arrays Cᵢ_{ₐ}, Cᵢ_{_{b}}ϵC, capturing the normalized co-occurrence of the items. To streamline the process, some example implementations precompute and store these values in a collaborative relationship matrix

$${R}_{C} = \frac{C \cdot {C}^{⊤}}{‖ C ‖ ‖ {C}^{⊤} ‖} ∈ {ℝ}^{n \times n} ,$$

which is typically very sparse.

### Example Scoring Rules

The score for an unseen item xϵI can, in some implementations, be calculated by averaging both the semantic and collaborative relationships between items in Sᵤ={s₁, s₂, . . . , sₙ} as follows:

$$score ( x ) = \frac{1}{n} {\sum }_{j = 1}^{n} {r}_{j} {λ}^{{t}_{j}} [ {aR}_{S}^{x j} + ( 1 - a ) {R}_{C}^{x j} ]$$

where

$${R}_{S}^{x j} and {R}_{C}^{x j}$$

represent the semantic and collaborative relationships between the unseen item x and item sⱼϵSᵤ, respectively. In this equation, rⱼ is the rating given by user u to item sⱼ, and λ^{t}^{ⱼ} is an exponential decay function applied to the temporal order tⱼ of sⱼ in the sequence Sᵤ. Here, tⱼ is set to 1 for the most recent item in Sᵤ and increments by 1 up to n for the oldest item. The framework outputs the top k items in descending order based on their scores.

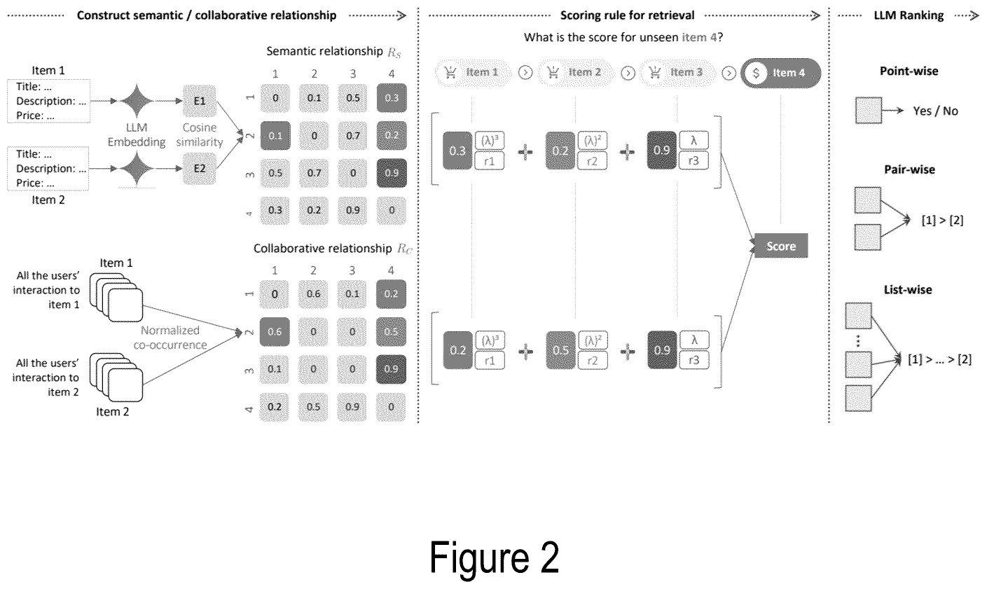

As one example, FIG. 2 illustrates an example graphical representation of an example framework. In particular, as illustrated in FIG. 2, some example implementations use the semantic relationship scores in R_{S} and the collaborative relationship scores in R_{C} to score the items in the user history compared to new items to recommend. The final score for one new item is a weighted average from the semantic relationship and collaborative relationship scores, with additional weights from the user's ratings r and a temporal decay λ<1 which prioritize recent interactions. The top scoring retrieved items are sent to the LLM Ranking, where some example implementations can use point-wise, pair-wise, or list-wise ranking approaches to further improve upon the scoring of recommended items.

### Example Ranking Pipeline:

After retrieving the top k items, denoted as Iₖ, from the initial retrieval process, a LLM can be employed to further rank these items to enhance the overall next-item recommendation quality. The items in Iₖ are already ordered based on scores from the retrieval framework, which reflect semantic, collaborative, and temporal information. Some example implementations intentionally incorporate this initial order into the ranking process to enhance both efficiency and effectiveness. This framework then leverages the capabilities of the LLM to better capture user preference, complex relationships and contextual relevance among the items.

### Example Rank Schema

Some example implementations leverage one or more of the following strategies for ranking:

(1) Point-wise evaluates each item xϵIₖ independently, based on the user sequence Sᵤ, to determine how likely it is that user u will interact with item x. If two items receive the same score, their rank follows the initial order from Iₖ;

(2) Pair-wise evaluates the preference between two items xᵢ, xⱼϵIₖ based on the user sequence Sᵤ. Some example implementations adopt a sliding window approach, starting from the items with the lowest retrieval score at the bottom of the list [?]. The LLM compares and swaps adjacent pairs, while iteratively stepping the comparison window one element at a time.

(3) List-wise evaluates the preference among multiple items xᵢ, . . . , x_{i+w}ϵIₖ based on the user sequence Sᵤ. This method also uses a sliding window approach, with a window size w and a stride d to move the window across the list, refining the ranking as it passes [?]. In this setup, pair-wise is a special case of list-wise with w=2 and d=1.

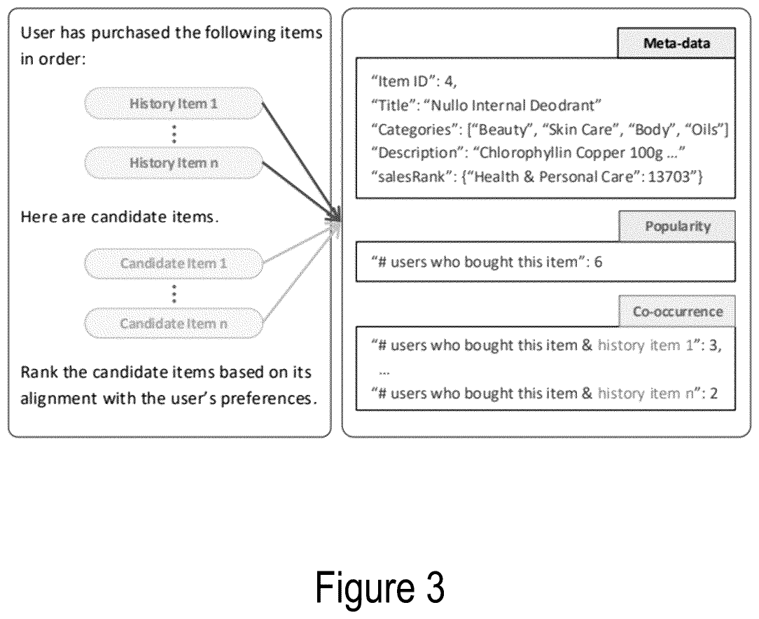

As one example, FIG. 3 illustrates an example prompt overview for the ranking pipeline. The prompt includes history items, candidate items, and instructions for the ranking strategy. Each item is represented by metadata, along with additional details such as popularity and co-occurrence, formatted in JSON. Full prompt is available in Appendix??.

### Example Item Information:

Some example implementations represent the metadata (e.g., Item ID, title, category, etc.) for each item in the user sequence sⱼϵSᵤ and each candidate item to be ranked xϵIₖ as JSON format in the input prompt. Additionally, some example implementations incorporate two more types of information that can help the reasoning capabilities of the LLM:

(1) Popularity can be calculated as the number of users who have interacted with the item x, simply by counting the occurrences in the training data. This popularity value is then included in the prompt for both the items in the user sequence sⱼϵSᵤ and the candidate item to be ranked xϵIₖ as “Number of users who interacted with this item: ###”;

(2) Co-occurrence can be calculated as the number of users who have interacted with both item x and item sⱼϵSᵤ. The resulting value is then included for candidate items xϵIₖ as “Number of users who interacted with both this item and item sⱼ: ###”.

### Example Devices and Systems

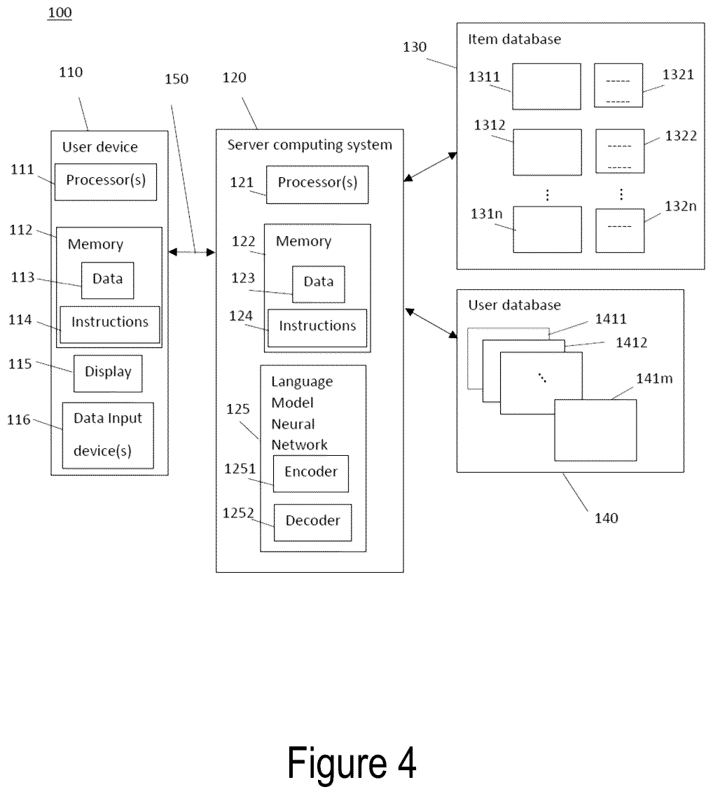

FIG. 4 depicts a block diagram of an example computing system 100 according to example embodiments of the present disclosure. The computing system 100 can be configured or operable to perform aspects of the present disclosure, including transmission of a recommendation of an item to a user of a user device 110.

The user device 110 can be any type of computing device, including a personal computer (e.g., desktop or laptop), a mobile computing device (e.g., smartphone or tablet), an embedded computing device, a server computing device, a network computing device such as a base station, router, beacon, other communication node, or other forms of computing devices. The user device 110 can include one or more processors 111 and a memory 112. The one or more processors 111 can be any suitable processing device (e.g., a processor core, a microprocessor, an ASIC, a FPGA, a controller, a microcontroller, etc.) and can be one processor or a plurality of processors that are operatively connected. The memory 112 can include one or more non-transitory computer-readable storage mediums, such as RAM, ROM, EEPROM, EPROM, flash memory devices, magnetic disks, etc., and combinations thereof. The memory 112 can store data 113 and instructions 114 which are executed by the processor(s) 111 to cause the computing device 110 to perform operations.

The user device 110 further includes at least one display device (screen) 115, and one or more data input devices 116 (e.g. a keyboard, mouse, microphone, etc.) for receiving commands from the user. The user device 110 is operative to process and implement the commands.

The computing system 100 further includes a server computing system 120 which is configured to communicate with the user device 110 using a communications network 150. The network 150 can be any type of communications network, such as a local area network (e.g., intranet), wide area network (e.g., Internet), or some combination thereof and can include any number of wired or wireless links. In general, communication over the network 142 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The server computer system 120 can include one or more processors 121 and a memory 122. The one or more processors 121 can be any suitable processing device (e.g., a processor core, a microprocessor, an ASIC, a FPGA, a controller, a microcontroller, etc.) and can be one processor or a plurality of processors that are operatively connected. The memory 122 can include one or more non-transitory computer-readable storage mediums, such as RAM, ROM, EEPROM, EPROM, flash memory devices, magnetic disks, etc., and combinations thereof. The memory 122 can store data 123 and instructions 124 which are executed by the processor(s) 121 to cause the server computing system 120 to perform operations.

In some implementations, the server computing system 120 includes or is otherwise implemented by more than one server computing device. The server computing devices may be located in multiple different locations, and configured to communicate over a communications network. In instances in which the server computing system 120 includes plural server computing devices, such server computing devices can operate according to sequential computing architectures, parallel computing architectures, or some combination thereof.

The server computer system 120 is configured to access two databases 130, 140. A first of the databases is an item database 130 storing data relating to a plurality of items, the number of the items being denoted by an integer value n. The database may include the items (depicted as 1311, 1312, . . . 131n) as digital files, for example in the case that the items are media items (such as items including any one or more of images, videos, audio tracks and text).

Alternatively, some or all of the items may be not be stored in the item database 130. For example, some or all of the items may be physical items such as products, and/or some or all of the items may be data items which are stored in a different location (for example, they may be webpages or documents stored on one or more separate server systems). In this case, the corresponding element depicted as 1311, 1312, . . . , or 131n in FIG. 4 may be an access dataset which contains data which can be used to obtain the item, e.g. a product reference number which can be used to order the corresponding item (e.g. from a supplier indicated in the access dataset) or at least one link to the digital item as stored on a separate server system.

In either case, item database 130 stores a respective text file 1321, 1322, . . . , 132n for each of the items. The text files 1321, 1322, 132n may be formed of text tokens (also called here simply “tokens”), e.g. encoding natural language. The tokens may each be one of the elements of a set of possible tokens called a “vocabulary”. For example, the vocabulary comprise any one or more of: letters of a natural alphabet (e.g. the Roman alphabet), complete natural language words, “word pieces” which are components of natural language words, punctuation marks, or codes defined by a code book (e.g. a code may indicate a property of the item, e.g. that it is intended for access by a certain user demographic, e.g. children, or belongs to a certain genre, e.g. opera or fantasy). The text files 1321, 1322, . . . , 132n may have been created at least partly manually, e.g. by a creator or supplier of the corresponding item, and/or may have been created at least partly automatically, e.g. by an automatic system which processes the corresponding item, and/or data about the corresponding item, and creates the text files 1321, 1322, . . . , 132n.

The n items may be labelled by an integer variable x which is in the range 1 to n, and the text file for item x would then be indicated as 132x in the notation of FIG. 4. The item x itself (if present in the database 130), or the access dataset for the item x, is indicated as 131x in the notation of FIG. 4.

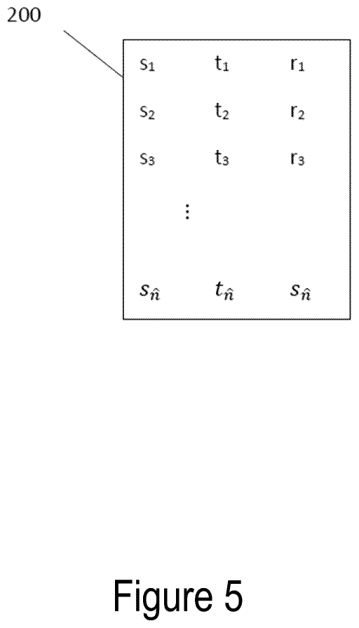

The other database depicted in FIG. 4 is a user database 140. The user database 140 stores, for each of the plurality of users, having a cardinality denoted m, a respective user file 1411, 1412, . . . , 141m. A suitable format for each of the user files is described below with reference to FIG. 5.

The server computer system 120 further includes a language model neural network 125, which is typically a large language model. The language model neural network 125 can be any appropriate language model neural network that receives an input sequence (also called a “prompt”) made up of text tokens selected from the vocabulary and is operative to generate from it an encoding which is a representation of the input sequence. This operation is performed by an encoder 1251 of the large language model 125. Many such language model neural networks are known, including those listed above.

The language model neural network 125 may further be operative to generate from the input sequence (prompt) an output sequence (language model output) made up of text tokens from the vocabulary, such as by using a decoder 1252. The language model neural network 125 may for example be of a type is referred to as an auto-regressive neural network because the language model neural network 125 auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence.

For example, the current input sequence when generating a token at any given position in the output sequence can include the input sequence and the tokens of the output sequence at any preceding positions that precede the given position in the output sequence. As a particular example, the current input sequence can include the input sequence followed by the tokens of the output sequence at any preceding positions that precede the given position in the output sequence. Optionally, the input and the current output sequence can be separated by one or more predetermined tokens within the current input sequence.

More specifically, to generate a particular token at a particular position within an output sequence, the neural network 125 (e.g. the decoder 1252) can process the current input sequence to generate a score distribution, e.g., a probability distribution, that assigns a respective score, e.g., a respective probability, to each token in the vocabulary of tokens. The neural network 125 can then select, as the particular token, a token from the vocabulary using the score distribution. For example, the neural network 125 can greedily select the highest-scoring token or can sample, e.g., using nucleus sampling or another sampling technique, a token from the distribution.

As a particular example, the language model neural network 125 may employ a decoder 1252 which an auto-regressive Transformer-based neural network that includes (i) a plurality of attention blocks that each apply a self-attention operation and (ii) an output subnetwork that processes an output of the last attention block to generate the score distribution.

Further examples of transformer-based language model neural networks which can be employed as the language model neural network 125 include those described in J. Hoffmann, et al, “Scaling language models: Methods, analysis & insights from training gopher”, CoRR, abs/2112.11446, 2021; C. Raffel, et al, “Exploring the limits of transfer learning with a unified text-to-text transformer”, arXiv preprint arXiv: 1910.10683, 2019; D. Adiwardana et al, “Towards a human-like open-domain chatbot”, CoRR, abs/2001.09977, 2020; and T. B. Brown, et al., “Language models are few-shot learners”, arXiv preprint arXiv: 2005.14165, 2020. Other examples are given in Appendix A.

In some implementations, the language model 125 is pre-trained, e.g. trained on a language modeling task that does not require providing item recommendations, and it may not have been fine-tuned for use in the recommendation system.

For example, the server computing system 120, or another training system, may have pre-trained the language model neural network 125 on a language modeling task, e.g., a task that requires predicting, given a current sequence of text tokens, the next token that follows the current sequence in the training data. As a particular example, the language model neural network 125 can be pre-trained on a maximum-likelihood objective on a large dataset of text, e.g., text that is publically available from the Internet or another text corpus.

Note that in alternative implementations of the presently disclosed concepts, the computing system which implements the concepts may have a different architecture from that of the computer system 100 depicted in FIG. 4. For example, the server computer system 120 may, rather than implementing the language model neural network 125 itself, communicate with an external computer apparatus (not shown) which hosts the language model neural network and which, in response to a prompt (input sequence) generated by the server computing system 120 and transmitted by it to the external computer apparatus, processes the prompt and thereby generates, and returns to the server computing system 120, an encoding of the prompt and/or a language model output (output sequence) which is an appropriate textual response to the prompt.

In another alternative implementation of the presently disclosed concepts, the functions of the server computing system 120 (and optionally, the item database 130 and user database 140) may be integrated into the user device 110, so that no separate server computing system 120 is required.

Turning to FIG. 5, an example user file 200 is shown which is one of the user files 1411, 1412, . . . , 141m stored in the use database 140 of FIG. 4. As described below, the computing system 100 is for providing a recommendation to a particular user, denoted u, who is one of the plurality of users, and the user file 200 is the user file for the particular user, but all other user files 1411, 1412, . . . , 141m may have the same format.

The user file 200 indicates \hat{n} items Sᵤ={s₁, s₂, . . . , s_{\hat{n}}} the particular user u has interacted with (e.g. bought or viewed). These \hat{n} are items are a subset of the n items (“plurality of items”) for which text files 1321, 1322, . . . , 132n are present in the item database 130. \hat{n} is less than n, so the subset Sᵤ={s₁, s₂, . . . , s_{\hat{n}}} is a proper subset of the plurality of elements. In fact, \hat{n} may be much less than n; for example \hat{n} may be less than 100, or less than 1000, whereas n may be at least thousands, and perhaps 10,000s, 100,000s or millions. The \hat{n} items may also be denoted by Sᵤ={s₁, s₂, . . . , sⱼ, . . . , s_{\hat{n}}} where j is an integer index in the range 1 to \hat{n}.

For each of value j, user file 200 contains a corresponding data element tⱼ indicative of a time since the particular user interacted with the item sⱼ (e.g. last interacted, in the case of items with which the user may have interacted more than once). The data element tⱼ may not indicate the corresponding time in absolute terms, but may only do so relative to the time(s) at which the particular user interacted with other of the elements in the subset. For example the set of values {t₁, t₂, . . . , tⱼ, . . . , t_{\hat{n}}} may just be the integers 1 to n in an order which specifies the order in which the user (e.g. last) interacted with the corresponding item.

For each of the \hat{n} items sⱼ, the user file 200 contains a corresponding data element rⱼ indicative of a rating the user has given the corresponding item. The rating rⱼ may for example be an integer selected from a range. In the case of any item sⱼ to which the user has not given a rating, a rating value rⱼ may be assigned automatically, e.g. as a default value, such as the center of the range, or an average of the ratings the user has given to other items of the subset Sᵤ.

### Example Methods

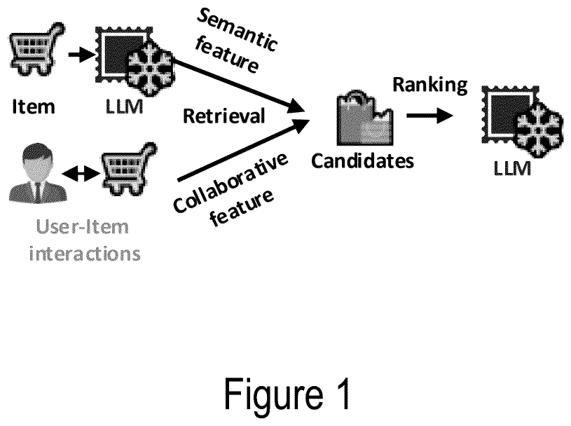

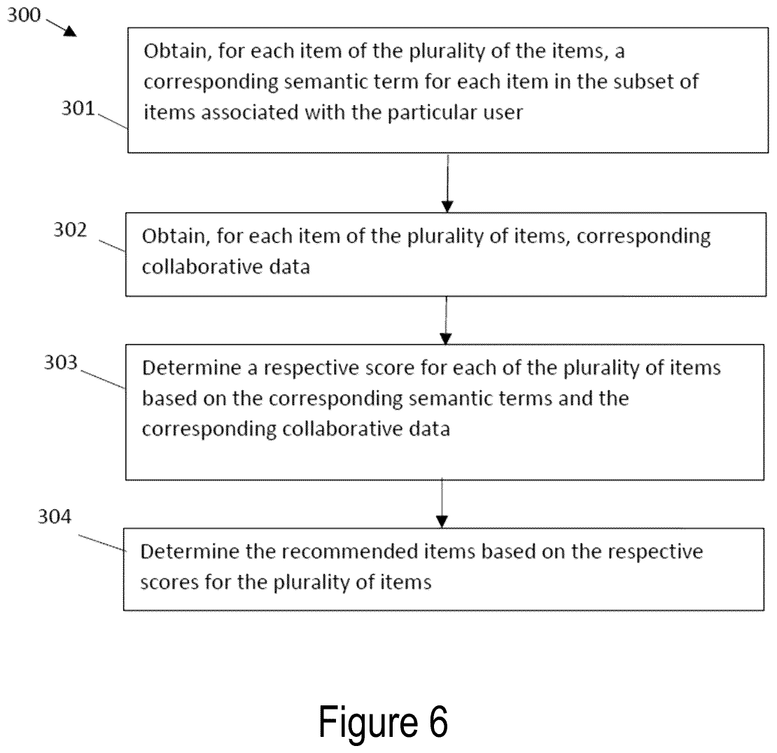

FIG. 6 sets forth an aspect associated with one or more computer-implemented methods according to example embodiments of the present disclosure. In some embodiments, the computer-implemented methods of FIG. 6 can include other features or steps disclosed herein. In some embodiments, a computing device, computing system, transmitter, receiver or other example system or device as described with reference to FIGS. 1 and 2 or other example systems or devices can implement the method depicted in FIG. 6. In some embodiments, one or more tangible, non-transitory computer-readable media storing computer-readable instructions that when executed by one or more processors cause the one or more processors to perform operations, the operations comprising steps as set forth in the method depicted in FIG. 6.

FIG. 6 depicts a flow chart diagram of an example method 300 to produce a recommendation learning according to example embodiments of the present disclosure.

The server computer system 120, appropriately programmed (e.g. by specifying operations using the instructions 124), can perform the method 300 of FIG. 6.

At 301, one or more computing devices (e.g. the server computer system 120), obtain, for each item x of the plurality of the items (i.e. for each of the n items), a corresponding semantic term

$${R}_{S}^{x j}$$

for each item sⱼ in the subset of items Sᵤ={s₁, s₂, . . . , sⱼ, . . . , s_{\hat{n}}} associated with the particular user u. The value

$${R}_{S}^{x j}$$

may be calculated as described above. Thus, each value

$${R}_{S}^{x j}$$

may be based on (e.g. is a cosine product of) encodings Eₓ and Eⱼ which are each dₑ-dimensional vectors, where dₑ is an integer. Eⱼ is in fact Eₓ in the case that x is sⱼ. Each encoding Eₓ is a corresponding row of a Eϵ [symbol] ^{n×d}^{ₑ}, and is the encoding produced by the language model neural network 125 of a prompt based on the corresponding text file 132x. The matrix E may be pre-computed, i.e. before the retrieval process begins. Furthermore, cosine products of Eₓ and Eⱼ may be pre-computed for all possible combinations of items x and sⱼ, so that “obtaining” the corresponding semantic term may amount to extracting the product of Eₓ and Eₓ from memory.

At 302, one or more computer devices (e.g. the server computing system 120) obtain, for each item x of the plurality of items, corresponding collaborative data. As discussed above, the collaborative data may comprise, for each item sⱼ in the subset of items associated with the particular user, a corresponding collaborative term

$${R}_{C}^{x j} .$$

Specifically, for each of the items x, a corresponding m-dimensional vector Cₓ may be formed which indicates whether each of the m users have indicated with that item. Each element of Cₓ may for example be 1 if the subset of items associated with corresponding one of the m users includes the item x, and 0 otherwise. In the case that item x is the item sⱼ, the vector is denoted Cⱼ. The collaborative term

$${R}_{C}^{x j}$$

may be formed as a measure of the similarity (e.g. the cosine product) between Cₓ and Cⱼ.

At 303, one or more computer devices (e.g. the server computing system 120) obtain a respective score for each of the plurality of items based on the corresponding semantic terms and the corresponding collaborative data. This may for example be done as described above in Eqn. (1). The value of λ^{t}^{ⱼ} given in Eqn. 1 is the result of applying a function λ to the variable tⱼ, and is a decreasing function of the time which has passed since the particular user (e.g. last) interacted with the item sⱼ.

At 304, one or more computing devices (e.g. the server computing system 120) determine one or more recommended item(s) based on (i.e. using) the respective scores of the n items. Following this determination, a recommendation specifying the recommended item(s) may be transmitted to the particular user. For example, if the particular user is the operator of the user device 110 of FIG. 5, the recommendation may be sent over the communications network 150 to the user device 110, which may display the recommended item(s) on the screen, e.g. by displaying data about the recommended items which is stored in the item database 130 and transmitted with the recommendation.

The determination of the recommended items based on the respective scores of the n items may be performed in various ways. In one possibility, k items for which the score is highest may be identified, and these may be selected as k recommended items. Here k is an integer which is at least one.

Alternatively, in the case that k is more than one, the k items may be treated as “candidates”. That is, the k items form a candidate subset of the plurality of data items I, and there may be a sub-step, within step 304, of “ranking” of the k candidates, following which the one or more recommended item(s) may be determined at the item(s) which have the highest ranking.

During the ranking sub-step, for each of the k candidate items, the server computing system 120 may define one or more prompts including the text data for the candidate item. Optionally, a single prompt may be defined including the text data for all the candidate items. Alternatively, a prompt may be defined for each respective one of the k candidate items and containing the text data for that candidate item. Alternatively, a prompt may be defined for each of a plurality of respective (proper) subsets of the k candidate items containing the text data for the subset of the candidate items.

The prompt(s) may be processed by a language model neural network (e.g. the language model neural network 125) to generate respective language model output(s), and the ranking may be performed based on the language model output(s).

As noted above, the prompt(s) may be formed in several ways, and each of the prompt(s) includes the text data of one or more of the candidate items. Optionally, each prompt may further specify the items in the subset of items associated with the particular user, and optionally the text data for the items in the subset of items associated with the particular user.

For example, one possible prompt may be as follows:

The user has purchased the following items in the following order:
[A list of the items in the subset associated with the user, optionally including some or all of the text data for those items]
Here are the candidate items
[A list of the candidate items, optionally including the text data of the candidate items]
Rank the candidate items based on their alignment with the user's preferences.
   Alternatively, another possible prompt may be as follows:
The user has purchased the following items in the following order:
[A list of the items in the subset associated with the user, optionally including some or all of the text data for those items]
Which of the following items is most aligned with the user's preferences?
[A list of a proper subset of the candidate items, optionally including the text data of the candidate items]

Optionally, the prompt may additionally include data indicative, for each of the candidate items, of a number of the plurality of users for whom the respective associated subset of the plurality of items includes the item of the candidate dataset. For example, this may read “The number of users who interacted with [a certain candidate item] was [number]”.

Alternatively or additionally, the prompt may optionally include, for one or more of the candidate items and for one or more other of the plurality of items (e.g. one or more other items of the candidate dataset, or one or more of the subset of items associated with the particular user), respective data indicative of a number of the plurality of users for whom the respective associated subset of the plurality of items includes both the item of the candidate dataset and the other item. For example, this may read “[number] users both interacted with [a certain candidate item] and with [a certain one of the items in the subset associated with the particular user].”

Using the language model output(s), the ranking may be performed in various ways. For example, if the prompt has the first format above, and, upon processing it, the language model generates a language model output which is a ranking of the candidate items, the final ranking may the one specified by the language model output.

Alternatively, an initial order of the candidate items may be defined, and iteratively adjusted (modified) based on the language model outputs. The initial order of the candidate items may be based on the scores. For example, the initial order may follow the scores of the candidate items, e.g. such that respective scores of the highest scoring candidates decrease monotonously from the first candidate item in the order to the last candidate item in the order. In each iteration, a “window” of two or more of the candidate items which have consecutive positions in the order may be selected, and the order of the candidate items in the window may be selectively adjusted upon a criterion being met. The criterion may, for example, be that a language model output indicates that a candidate item in the window which is later in the order, would in fact be more popular with the particular user than a candidate item in the window which is earlier in the order. For example, the prompt may be of the second format above, and may ask the language model neural network which of a proper subset of the candidate items (e.g. two or more items in the window) is most aligned with the user's preferences. If the corresponding language model output indicates that two or of the items have an alignment with the user's preferences which is different from that suggested by their respective scores, the initial order of the candidate items may be changed, so as to rank the item(s) which, according to the language model output, are more closely aligned with the user's preferences, more highly.

Following one or more iterations of adjusting the order of the candidate items, one or more items which are ranked most highly in the adjusted order may be selected as the recommended item(s), and a recommendation specifying the recommended items may be transmitted to the user via the user device 110.

Following step 304, the user device 110 may be configured to provide the recommendation to the particular user, e.g. by displaying the recommendation on the screen 115.

The user may then use the data input device(s) 116 to enter a command into the user device 110 which instructs the user device 110 to obtain one or more of the recommended item(s), which are referred to as selected item(s).

For example, if the selected items are stored in the item database 130, the user device 110 may communicate with the server computing system 120 to command the server computing system 120 to extract the selected item(s) from the item database 130 and transmit the item(s) to the user device 110.

Alternatively, if the selected item(s) are not stored in the item database 130 (in other words, if the corresponding one of the elements 1311, 1312, . . . , 131n depicted in FIG. 5 is an access dataset indicating how to obtain the selected item), the user device 110 may be configured to use the access dataset for each selected item to obtain the recommended item(s). The user device 110 may obtain the access dataset for each selected item together with the recommendation, or separately; for example, after receiving the user command to obtain the selected item(s), the user device 110 may be configured to transmit to the server computing system 120 a request for the access dataset(s) corresponding to the selected item(s).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

In particular, although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

For example, in a variation of FIG. 6, the step of obtaining the semantic terms (step 301) or the step of obtaining the collaborative data (step 302) may be omitted, and the score for each of the plurality of items may be determined based only whichever one of the semantic terms or the collaborative data was obtained. Step 304 may, however, be performed in one of the ways described above, based on language output(s) generated by the language model. The concept of providing a retrieval process (either using all of steps 301-303, or in the simplified manner described in this paragraph which omits either step 301 or step 302), followed by a ranking process as described above with reference to step 304, constitutes an independent aspect of the present disclosure. This aspect may be expressed as a computer-implemented method, as a computer system configured to perform the method, or as one or more tangible, non-transitory computer-readable media storing computer-readable instructions that when executed by one or more processors cause the one or more processors to perform the method.

What is claimed is:

1. A computer-implemented method for obtaining a recommendation which specifies one or more recommended items selected from a plurality of items, each of the plurality of items being associated with respective text data,
the recommendation being for a particular user who is one of a plurality of users, each user of the plurality of users being associated with a respective subset of the plurality of items,
the method comprising:
obtaining, for each item of the plurality of the items, a corresponding semantic term for each item in the subset of items associated with the particular user, the sematic term being a measure of the similarity between an encoding by an embedding portion of a language model neural network of a prompt based on the text data of the item of the plurality of items, and an encoding by the embedding portion of the language model neural network of a prompt based on the text data of the item in the subset of items associated with the particular user;
obtaining, for each item of the plurality of items, corresponding collaborative data indicative of a similarity between ones of the users for whom the associated subset of items includes the item and ones of the users for whom the associated subset of items includes items in the subset of items associated with the particular user;
determining a respective score for each of the plurality of items based on the corresponding semantic terms and the corresponding collaborative data; and
determining the recommended items based on the respective scores for the plurality of items.

2. The method according to claim 1, in which obtaining the collaborative data for each item of the plurality of items, comprises
obtaining, for each item of the subset of items associated with the particular user, a corresponding collaborative term indicative of the similarity between the users for whom the associated subset includes the item, and the users for whom the associated subset includes the item of the subset of items associated with the particular user.

3. The method of claim 2, in which the respective score for each of the plurality of items is a weighted sum, over the items in the subset of the items associated with the particular user, of the corresponding semantic term and the corresponding collaborative term.

4. The method of claim 3, in which the weighted sum over the items in the subset of items associated with the particular user is a sum over the items in the subset of items associated with the particular user, of a respective weight for the corresponding item in the subset of items associated with the particular user multiplied by a weighted sum of the corresponding semantic term and the corresponding collaborative term.

5. The method of claim 4, in which each item in the subset of items associated with the particular user is associated with a respective rating assigned by the particular user, and the respective weight for each item in the subset of items associated with the particular user is based on the respective rating.

6. The method of claim 4, in which each item in the subset of items associated with the particular user is associated with a respective temporal value indicative of a time which has passed since the particular user has interacted with the item, and the respective weight for each item in the subset of items associated with the particular user is a decreasing function of the respective time which has passed since the particular user has interacted with the item.

7. The method of claim 1, in which said determining at least one recommended item based on the respective scores for the plurality of items, comprises:
identifying a candidate subset of the plurality of items for which the respective scores are highest;
using a language model neural network to process at least one prompt including the text data of the candidate items to generate a respective language model output; and
selecting the at least one recommended item based on the language model neural network outputs.

8. The method of claim 7, in which the at least one prompt further includes data indicative of a number of the plurality of users for whom the respective associated subset of the plurality of items includes an item of the candidate dataset.

9. The method of claim 7, in which, the at least one prompt further includes, for an item of the candidate dataset, data indicative of a number of the plurality of users for whom the respective associated subset of the plurality of items includes both the item of the candidate dataset and another item of the candidate dataset.

10. The method of claim 7, in which, the at least one prompt further includes, for an item of the candidate dataset, data indicative of a number of the plurality of users for whom the respective associated subset of the plurality of items includes both the item of the candidate dataset and an item of the subset of the plurality of items associated with the particular user.

11. The method of claim 7, in which said determining at least one recommended item based on the respective scores for the plurality of items, comprises:
determining an initial order of the items of the candidate subset;
at least once selecting two or more of the items in the candidate subset which have consecutive positions in the order, and adjusting the order of the items in the candidate subset by adjusting the order of the two or more items; and
selecting the at least one recommended item based on the adjusted order of the items of the candidate subset.

12. The method of claim 11 in which the initial order of the items in the candidate dataset is based on the respective scores of the items of the candidate subset.

13. A computing system for obtaining, for a user who is one of a plurality of users, a recommendation which specifies one or more recommended items selected from a plurality of items, each of the plurality of items being associated with respective text data, and each user of the plurality of users being associated with a respective subset of the plurality of items, the computing system comprising:
at least one processor; and
at least one tangible, non-transitory computer-readable medium that stores instructions that, when executed by the at least one processor, cause the computing system to:
obtain, for each item of the plurality of the items, a corresponding semantic term for each item in the subset of items associated with the particular user, the sematic term being a measure of the similarity between an encoding by an embedding portion of the language model neural network of a prompt based on the text data of the item of the plurality of items, and an encoding by the embedding portion of the language model neural network of a prompt based on the text data of the item in the subset of items associated with the particular user;
obtain, each item of the plurality of items, corresponding collaborative data indicative of a similarity between ones of the users for whom the associated subset of items includes the item and ones of the users for whom the associated subset of items includes items in the subset of items associated with the particular user;
determine a respective score for each of the plurality of items based on the corresponding semantic terms and the corresponding collaborative data; and
determine the recommended items based on the respective scores for the plurality of items.

14. One or more tangible, non-transitory computer-readable media storing computer-readable instructions that when executed by one or more processors cause the one or more processors to perform a plurality of operations to obtain, for a user who is one of a plurality of users, a recommendation which specifies one or more recommended items selected from a plurality of items, each of the plurality of items being associated with respective text data, and each user of the plurality of users being associated with a respective subset of the plurality of items, the operations comprising:
obtaining, for each item of the plurality of the items, a corresponding semantic term for each item in the subset of items associated with the particular user, the sematic term being a measure of the similarity between an encoding by an embedding portion of the language model neural network of a prompt based on the text data of the item of the plurality of items, and an encoding by the embedding portion of the language model neural network of a prompt based on the text data of the item in the subset of items associated with the particular user;
obtaining, for each item of the plurality of items, corresponding collaborative data indicative of a similarity between ones of the users for whom the associated subset of items includes the item and ones of the users for whom the associated subset of items includes items in the subset of items associated with the particular user;
determining a respective score for each of the plurality of items based on the corresponding semantic terms and the corresponding collaborative data; and
determining the recommended items based on the respective scores for the plurality of items.
